(19) United States
(12) Patent Application Publication
(10) Pub. No.: US 2026/0295736 A1
(43) Pub. Date: Oct. 1, 2026

(54) NON-MAGNETIZATION MODIFICATION SOURCE-CONTAINING PASTE, NON-MAGNETIZATION DEVICE, ROTOR CORE, AND METHOD FOR MANUFACTURING THE SAME

(71) Applicant: HONDA MOTOR CO., LTD., Tokyo (JP)

(72) Inventors: Yoshiyuki NAKAZAWA, Wako-shi (JP); Hitoshi ITAMI, Wako-shi (JP); Naoyoshi UMEDA, Wako-shi (JP); Kazuki MATSUURA, Wako-shi (JP); Kai TSUNEKAWA, Wako-shi (JP)

(21) Appl. No.: 19/578,006

(22) Filed: Mar. 25, 2026

(30) Foreign Application Priority Data
Mar. 31, 2025 (JP) 2025-059315

(51) Int. Cl. B23K 35/30; B23K 1/00; B23K 35/02; B23K 35/36; B23K 101/36; B23K 103/04; B32B 15/01; H02K 1/02; H02K 15/021

(52) U.S. Cl. CPC B23K 35/3026; B23K 1/0016; B23K 35/025; B23K 35/3613; B32B 15/011; H02K 1/02; H02K 15/021; B23K 2101/36; B23K 2103/04; B32B 2307/208; B32B 2311/30

(57) ABSTRACT

A rotor core in which electrical steel sheets each including a Fe—Si alloy are layered with an insulation coating being interposed between the electrical steel sheets. The electrical steel sheets each include a bridge portion including a Fe—Si—Mn—C alloy, the bridge portion having been subjected to non-magnetization modification with a non-magnetization modification source-containing paste including a manganese powder which is a non-magnetization modification source and a resin ink containing a component capable of being carbonized by heating.

### CROSS REFERENCE TO RELATED APPLICATIONS

This application claims the foreign priority benefit under 35 U.S.C. § 119 of Japanese patent application No. 2025-059315, filed on Mar. 31, 2025, the disclosure of which is incorporated herein by reference.

### BACKGROUND OF THE INVENTION

### 1. Field of the Invention

The present invention relates to a non-magnetization modification source-containing paste, a non-magnetization device, a rotor core, and a method for manufacturing the same.

### 2. Description of the Related Art

In recent years, efforts to achieve a low-carbon society or a decarbonized society have been active, and for vehicles as well, research and development on electric vehicles which travel by using rotational powers of rotating electrical machines have been conducted in order to reduce CO₂ emissions and improve energy efficiencies.

Conventionally, as a rotor core of a rotating electrical machine, a rotor core which includes bridge portions (also referred to as reinforcement ribs) around housing holes of permanent magnets has been known (see, for example, Patent Literature 1). The bridge portions enhance a centrifugal strength in the rotor core when the rotor rotates.

In addition, the bridge portions are subjected to non-magnetization modification processing. Specifically, a metal powder for modification, which has been sprayed and attached to the surfaces of the bridge portions, is irradiated with a laser beam to alloy a metal component of the bridge portions and the metal powder for modification. This inhibits the generation of leakage magnetic flux in the bridge portions when the rotor rotates. The rotating electrical machine including this rotor core can prevent a decrease in efficiency.

### Citation List

### Patent Literature

Patent Literature 1: WO2022/004672

### SUMMARY OF THE INVENTION

However, since the non-magnetization of bridge portions in the conventional rotor core (see, for example, WO2022/004672) is performed by alloying the metal powder for modification, which has been attached to the surfaces of the bridge portions, and the metal component of the bridge portions, there is a problem that the non-magnetization of the bridge portions cannot be sufficiently and stably performed.

In addition, it is desirable that bridge portions of a rotor core be formed thinly in order to reduce a reflux of magnetic flux at the time of rotation of a rotor; however, there is a problem that if the bridge portions are thinner, a necessary centrifugal strength cannot be ensured.

In view of this, an object of the present invention is to provide a non-magnetization modification source-containing paste, a non-magnetization device, a rotor core, and a method for manufacturing the same, which make it possible to perform non-magnetization modification of bridge portions more sufficiently and stably than the conventional technique, and also to obtain a rotor core excellent in centrifugal strength of bridge portions. Then, the present invention in turn contributes to an improvement in energy efficiency.

A first aspect of the present invention that achieved the above-described object is a non-magnetization modification source-containing paste containing a non-magnetization modification source configured to be melted by heating in a post-process on a portion that needs non-magnetization modification in an electrical steel sheet in a post-process, the non-magnetization modification source-containing paste including a manganese powder that is the non-magnetization modification source and a resin ink that contains a component capable of being carbonized by heating.

A second aspect of the present invention that achieved the above-described object is a non-magnetization device that non-magnetizes each of specific portions formed by applying the non-magnetization modification source-containing paste to portions that need non-magnetization modification in an electrical steel sheet by heating and melting the each of the specific portions, the non-magnetization device including a laser beam irradiator that melts specific portions by changing a laser beam irradiation position so as to correspond to specific portions and a controller that controls a laser beam irradiation position of the laser beam irradiator. The controller divides portions that need non-magnetization modification in an electrical steel sheet into groups, and controls a laser beam irradiation position such that timings for melting by heating for the groups do not overlap each other.

In addition, a third aspect of the present invention that achieved the above-described object is a rotor core in which electrical steel sheets each including a Fe—Si alloy are layered with an insulation coating being interposed between the electrical steel sheets. The electrical steel sheets each include a bridge portion including a Fe—Si—Mn—C alloy, the bridge portion having been subjected to non-magnetization modification with the non-magnetization modification source-containing paste.

In addition, a fourth aspect of the present invention that achieved the above-described object is a method for manufacturing a rotor core by using the non-magnetization modification source-containing paste, the method including applying a non-magnetization modification source-containing paste to portions that need non-magnetization modification in an electrical steel sheet and solidifying heated and melted portions after dividing portions to which a non-magnetization modification source-containing paste has been applied in an electrical steel sheet into groups and heating and melting portions such that timings for melting by heating for the groups do not overlap each other.

The present invention makes it possible to provide a non-magnetization modification source-containing paste, a non-magnetization device, a rotor core, and a method for manufacturing the same, which make it possible to perform non-magnetization modification of bridge portions more sufficiently and stably than the conventional technique, and also to obtain a rotor core excellent in centrifugal strength of bridge portions to be obtained.

### BRIEF DESCRIPTION OF THE DRAWINGS

FIG. 1 is a configuration explanatory view of a rotating electrical machine including a rotor core according to an embodiment of the present invention.

FIG. 2 is a partial perspective view of an electrical steel sheet included in the rotor core according to the embodiment of the present invention.

FIG. 3 is a manufacturing step diagram of the rotor core according to the embodiment of the present invention.

FIG. 4 is an explanatory view of an application step for a non-magnetization modification source-containing paste, which is shown in FIG. 3.

FIG. 5 is a schematic view showing how blocks formed by applying the non-magnetization modification source-containing paste in a non-magnetization modification step for the electrical steel sheet, which is shown in FIG. 3, are divided into groups.

FIG. 6 is a schematic view showing how the electrical steel sheet to which the non-magnetization modification source-containing paste has been applied is partially irradiated with a laser beam in the non-magnetization modification step for the electrical steel sheet, which is shown in FIG. 3.

FIG. 7 is a configuration explanatory view of a non-magnetization device according to the embodiment of the present invention.

FIG. 8 is a schematic view showing irradiation traces of the laser beam to the electrical steel sheet.

FIG. 9 is an explanatory view of a compression and insulation processing step, which is shown in FIG. 3.

FIG. 10 is an explanatory view of a blanking and in-die stacking step, which is shown in FIG. 3.

FIG. 11 is a graph showing a relation among the proportion of a ferromagnetic phase (%), the concentration of carbon [C] (% by weight), and the concentration of manganese [Mn] (% by weight) in a non-magnetization modified portion of the electrical steel sheet.

### DETAILED DESCRIPTION OF THE EMBODIMENTS

Next, a mode for carrying out the present invention (an embodiment) will be described in detail with reference to the drawings as appropriate.

A non-magnetization modification source-containing paste according to the present embodiment is used for manufacturing a rotor core which is included in a rotating electrical machine, and is used for non-magnetization modification of bridge portions of electrical steel sheets which form the rotor core.

Hereinafter, first, the rotor core of the rotating electrical machine will be described, and then a method for manufacturing a rotor core, a non-magnetization modification source-containing paste used in this manufacturing method, and a non-magnetization device will be described.

### Rotor Core

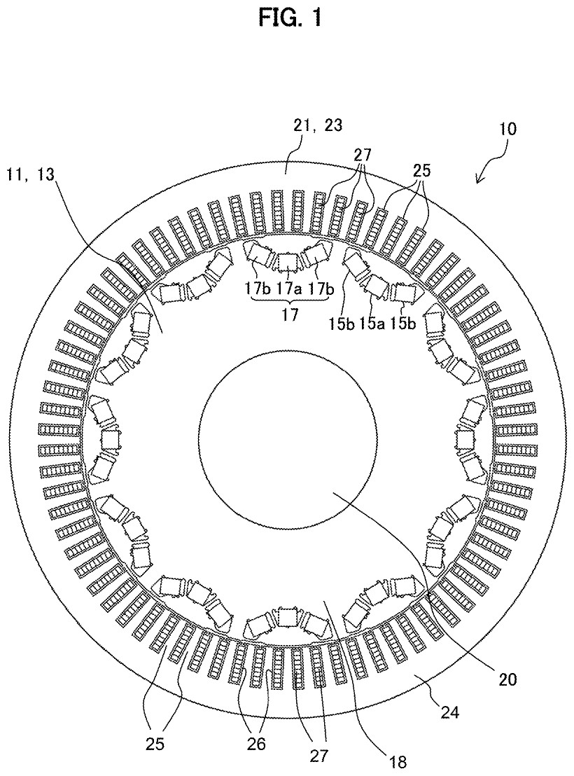

FIG. 1 is a configuration explanatory view of a rotating electrical machine 10 including a rotor core 13 according to the present embodiment, and is a sectional view of the rotating electrical machine 10 which is perpendicular to an axis of the rotating electrical machine 10.

The rotating electrical machine 10 is assumed to be a rotating electrical machine which is mounted on a hybrid vehicle or an electric vehicle and used as an electric motor for driving the vehicle, but can be used for various other uses.

As shown in FIG. 1, the rotating electrical machine 10 is configured to include a cylindrical rotor 11 and an annular stator 21.

The rotor 11 is disposed on an inner peripheral side of the stator 21 to be coaxial with the stator 21. This allows an outer peripheral surface of the rotor 11 to have a slight gap to an inner peripheral surface of the stator 21. The rotor 11 is capable of rotating on the inner peripheral side of the stator 21 about a rotor shaft 20 which is integrated with the rotor 11.

On the rotor core 13 included in the rotor 11, permanent magnets 17 formed of a neodymium magnet or the like are disposed. The permanent magnets 17 are disposed along a circumferential direction on an outer peripheral side of the rotor core 13. Each permanent magnet 17 is a rod-shaped body having a rectangular section, and extends in an axial direction of the rotor core 13 (a direction perpendicular to the sheet surface of FIG. 1).

Specifically, three permanent magnets 17 are combined as one set, and are arranged side by side at equal intervals in the circumferential direction.

In the sectional view shown in FIG. 1, the three permanent magnets 17 included in this set form a substantially V-shape which is open to an outer side in a radial direction with a permanent magnet 17a which is located at a center in the circumferential direction, and a pair of permanent magnets 17b, 17b which are disposed to sandwich the permanent magnet 17a at the center in the circumferential direction. That is, among the three permanent magnets 17, the pair of permanent magnets 17b, 17b are disposed to be close to the outer peripheral surface of the rotor core 13, and the permanent magnet 17a at the center is displaced to an inner side in the radial direction relative to the pair of permanent magnets 17b, 17b.

The three permanent magnets 17 included in the set are inserted through magnet housing holes 15a, 15b, 15b which are formed in the rotor core 13 to correspond to positions of the respective permanent magnets 17a, 17b, 17b, and are thus attached to the rotor core 13.

The rotor core 13 as described above is configured by stacking, in the axial direction of the rotating electrical machine 10, electrical steel sheets 18 each having a planar shape corresponding to a planar shape of the rotor core 13.

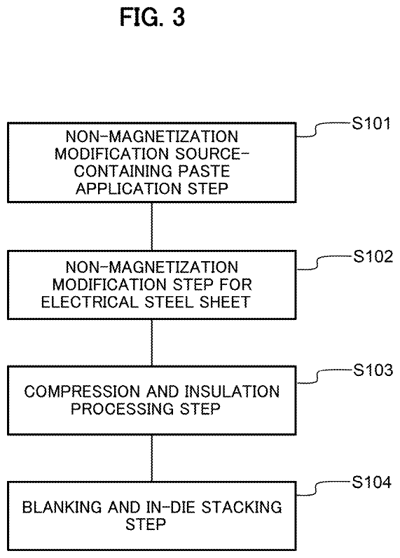

Each electrical steel sheet 18 is blanked from an electrical steel sheet 22 (see FIG. 3), which will be described later, to correspond to the planar shape of the rotor core 13.

The electrical steel sheet 18 in the present embodiment is preferably formed of a Fe—Si alloy.

The thickness of the electrical steel sheet 18 is preferably 0.1 mm or more and 0.5 mm or less.

Note that in FIG. 1, Reference sign 23 indicates a stator core of the stator 21, Reference sign 24 indicates a yoke of the stator 21, and Reference sign 27 indicates a coil which is disposed in a slot 26 to be wound around teeth 25 of the stator 21.

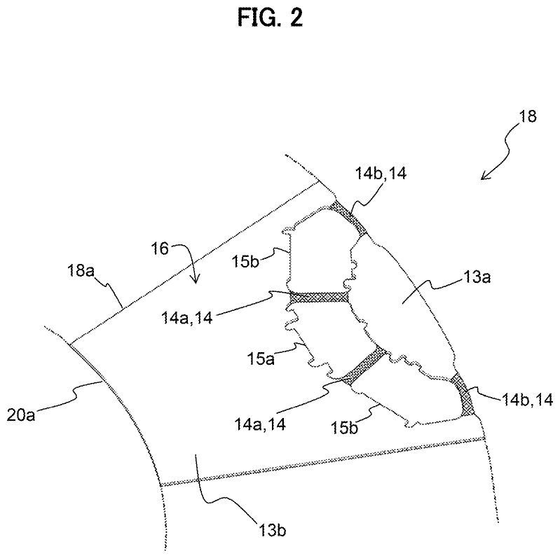

FIG. 2 is a partial perspective view of the electrical steel sheet 18 included in the rotor core 13 (see FIG. 1). For the convenience of illustration, FIG. 2 shows a portion where the three permanent magnets 17 (see FIG. 1) included in a set are attached in an enlarged manner. In FIG. 2, Reference sign 20a indicates an attachment hole which is formed on the inner peripheral side of the electrical steel sheet 18, to which the rotor shaft 20 (see FIG. 1) is attached.

As shown in FIG. 2, on the outer peripheral side of the electrical steel sheet 18, the three magnet housing holes 15a, 15b, 15b which correspond to the three permanent magnet 17a, 17b, 17b (see FIG. 1) which form the set are formed.

That is, as shown in FIG. 2, the magnet housing holes 15a, 15b, 15b form a substantially V-shape which is open to the outer side in the radial direction with a magnet housing hole 15a which is located at a center in the circumferential direction, and a pair of magnet housing holes 15b, 15b which are disposed to sandwich the magnet housing hole 15a at the center in the circumferential direction.

In addition, the electrical steel sheet 18 includes bridge portions 14 which connect an outer core portion 13a and an inner core portion 13b. In FIG. 2, the bridge portions 14 are shaded for the convenience of illustration.

As shown in FIG. 2, the bridge portions 14 include inner bridge portions 14a which are formed between the magnet housing hole 15a and the magnet housing holes 15b, and outer bridge portions 14b which are formed between end edges of the outermost periphery sides in the magnet housing hole 15b and the outer peripheral edge of the electrical steel sheet 18.

These bridge portions 14 have a reduced permeability as compared with a general portion 18a of the electrical steel sheet 18. The permeability of the bridge portions 14 is reduced (non-magnetized) by the alloying with a metal component (modification source) contained in the non-magnetization modification source-containing paste which will be described later.

Specifically, the bridge portions 14 contain a Fe—Si—Mn—C alloy.

Note that the concentration of carbon [C] (% by weight) in the bridge portions 14 is preferably 0.1% by weight or more, and more preferably 0,2% by weight or more. In addition, the concentration of manganese [Mn] (% by weight) in the bridge portions 14 is preferably 10% by weight or more, and more preferably 15% by weight or more.

The bridge portions 14 set to have the concentration of carbon [C] (% by weight) within such range and the concentration of manganese [Mn] (% by weight) have a sufficiently reduced permeability (non-magnetized), and have a high centrifugal strength.

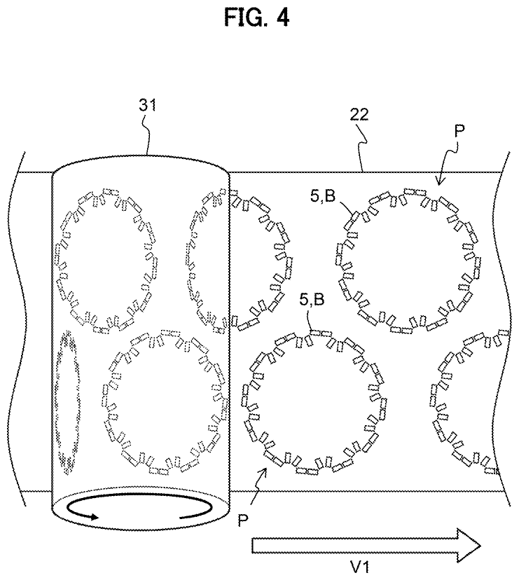

Note that in FIG. 2, Reference sign 16 indicates an insulation coating which is formed at nanometer level to micrometer level on both surfaces of the electrical steel sheet 18. The insulation coating 16 in the present embodiment is assumed to be formed in advance on the electrical steel sheet 22 (see FIG. 4) described later, which serves as a raw sheet of the electrical steel sheet 18.

### Method for Manufacturing Rotor Core

Next, a method for manufacturing the rotor core 13 (see FIG. 1) will be described.

FIG. 3 is a manufacturing step diagram of the rotor core 13 (see FIG. 1).

As shown in FIG. 3, this manufacturing method includes an application step for the non-magnetization modification source-containing paste to the electrical steel sheet 22 (step S101) (see FIG. 4), which will be described later, a non-magnetization modification step for the electrical steel sheet 22 (step S102) (see FIG. 4), a compression and insulation processing step (step S103) for the electrical steel sheet 22 (see FIG. 4) subjected to the non-magnetization modification, and blanking and in-die stacking step (step S104) of blanking the electrical steel sheet 18 (see FIG. 2) from the electrical steel sheet 22 (see FIG. 4) and stacking the electrical steel sheet 18.

FIG. 4 is an explanatory view of the application step (step S101) for the non-magnetization modification source-containing paste, which is shown in FIG. 3. Hereinafter, the non-magnetization modification source-containing paste is sometimes referred to simply as a “paste”.

In this application step, as shown in FIG. 4, the paste 5 is applied to the surface of the electrical steel sheet 22, which serves as the raw sheet of the electrical steel sheet 18 (see FIG. 2).

Here, the paste 5 will be described.

The paste 5 of the present embodiment contains a manganese powder which is a non-magnetization modification source, a resin ink, a thixotropy-imparting agent, and an organic solvent.

As the manganese powder, an undersized component which is formed of metallic manganese and which is obtained using a sieve having a mesh size of 75 μm compliant with JIS Z 8801 can be used, and preferably the manganese powder is one having a median diameter (D50) of around 10 μm as measured by a laser diffraction and scattering method. However, the manganese powder is not limited to these.

The content of the manganese powder in the paste 5 is preferably 85.0 to 95.0% by weight.

The resin ink includes, for example, organic binders including cellulose-based polymers such as ethyl cellulose and hydroxyethyl cellulose, acrylic resins such as polybutyl methacrylate, polymethyl methacrylate, and polyethyl methacrylate, epoxy resins, phenol resins, alkyd resins, polyvinyl alcohol, polyvinyl butyral, and the like, but is not limited to these. Among these, an acrylic resin is preferable.

The resin ink functions as a component which binds and adjust the manganese powder into the form of paste in the paste 5, and also functions as a carbon source of carbon atoms to be dispersed into the electrical steel sheet 22 (see FIG. 4) in the non-magnetization modification step of step S102 (see FIG. 3), which will be described later.

The content of the resin ink in the paste 5 is preferably 0,3 to 1.0% by weight.

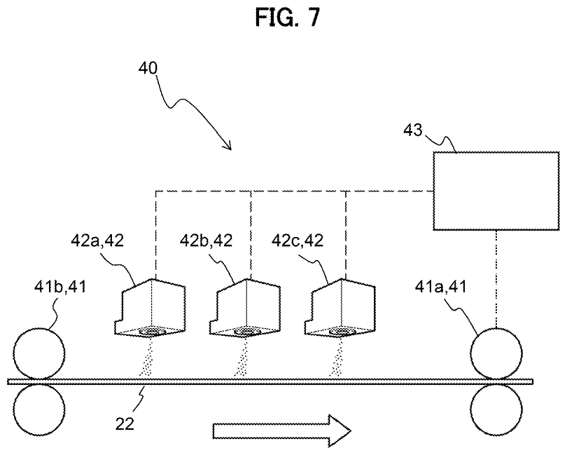

The thixotropy-imparting agent includes, for example, organic thixotropy-imparting agents such as hydrogenated castor oil and stearic acid amide, but is not limited to these. The thixotropy-imparting agent in the present embodiment imparts shape retention properties to the non-magnetization modification source-containing paste applied in the application step (see FIG. 7) for the paste 5 to the electrical steel sheet, which will be described later. In addition, the thixotropy-imparting agent also function as a carbon source of carbon atoms to be dispersed into the electrical steel sheet in the non-magnetization modification step (see FIG. 7), which will be described later.

The content of the thixotropy-imparting agent in the paste 5 is preferably 0.5 to 1.5% by weight.

The organic solvent includes, for example, ester-based solvents such as butyl cellosolve acetate and Butyl CARBITOL Acetate (BCA: diethylene glycol monobutyl ether acetate), ether-based solvents such as Butyl CARBITOL (BC: diethyleneglycol monobutyl ether), ethylene glycol, diethylene glycol derivatives, toluene, xylene, mineral spirits, terpineol, menthanol, and the like, but is not limited to these. Among these, Butyl CARBITOL is preferable.

The organic solvent imparts fluidity to the paste 5, and also functions as a carbon source of carbon atoms to be dispersed into the electrical steel sheet in the non-magnetization modification step (see FIG. 7), which will be described later.

The content of the organic solvent in the paste 5 is preferably 2.5 to 15,0% by weight.

The paste 5 can be prepared by mixing the above-described constituent components.

Referring back to FIG. 4, in the application step (step S101 of FIG. 3) for the paste 5, the paste 5 is applied as blocks B having a minute cuboid shape to specific portions of the electrical steel sheet 22 which correspond to the bridge portions 14 (see FIG. 2) of the electrical steel sheet 18 (see FIG. 2) where the non-magnetization modification is required.

This block B has a rectangular plane which encompasses the bridge portion 14 (see FIG. 2). In addition, the thickness of the block B is 0.25 mm or more such that the concentration of manganese contained in the paste 5 becomes 30% or more in weight proportion to the bridge portion 14 (see FIG. 2) as described in detail later.

As shown in FIG. 4, such blocks B form a block group which is aligned on the circumference to correspond to bridge portions 14 (see FIG. 2) in a single electrical steel sheet 18 (see FIG. 2). The block group of these block B forms an application pattern P of the paste 5.

Then, the application patterns P of the paste 5 in the present embodiment are arranged such that two rows of the application patterns P in a width direction of the electrical steel sheet 22 continue to form a staggered pattern at 60 degrees to a longitudinal direction of the electrical steel sheet 22.

Note that as shown in FIG. 4, the application of the paste 5 in the present embodiment is assumed to be performed by using a cylindrical rotating body 31 which has, on a peripheral surface thereof, through-holes H corresponding to the application patterns P. Specifically, in this application method, the paste 5 is supplied to the inside of the rotating body 31 which rotates in contact with and in synchronization with the electrical steel sheet 22 which is conveyed at a feed speed V1. On the surface of the electrical steel sheet 22, the application patterns P are formed continuously in the longitudinal direction of the electrical steel sheet 22 by the paste 5 pushed out through the through-holes H of the rotating body 31.

In the non-magnetization modification step (step S102) shown in FIG. 3, each of the blocks B (see FIG. 4) which form the application patterns P (see FIG. 4) is irradiated with a laser beam. In this way, a metal component which forms the electrical steel sheet 22 and the manganese powder which is contained in the paste 5 are melted by heating to form a Fe—Si—Mn alloy. The electrical steel sheet 22 in portions where the paste 5 has been applied is subjected to the non-magnetization modification, so that the permeability decreases.

In addition, in the non-magnetization modification step (step S102), by the irradiation with the laser beam, the resin ink contained in the paste 5 is calcined. Carbon atoms generated by carbonization of the calcined resin ink are dispersed into the electrical steel sheet 22 to form a Fe—Si—Mn—C alloy. The Fe—Si—Mn—C alloy is considered to contribute to an increase in hardness of the electrical steel sheet 22 in the portions where the paste 5 has been applied, so that the strength of the electrical steel sheet 22 in the portions where the bridge portions 14 are formed can be improved.

At this time, in the non-magnetization modification step in the present embodiment, the blocks B formed by applying the paste 5 are divided into groups, and each group thus divided is irradiated with the laser beam.

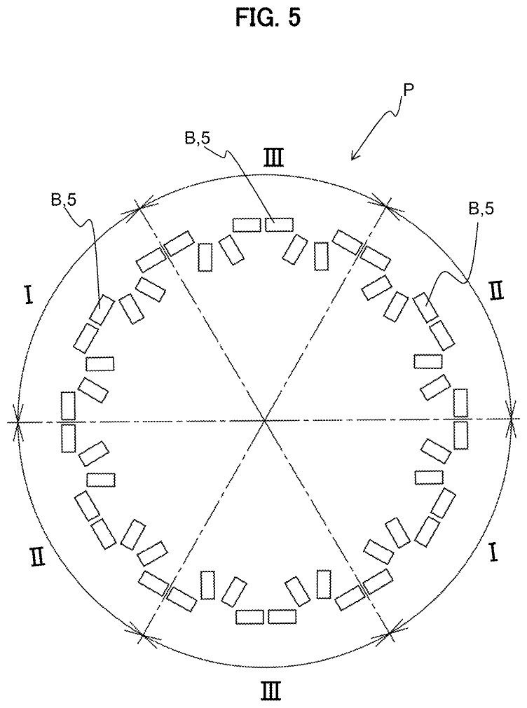

FIG. 5 is a schematic view showing how blocks B formed by applying the paste 5 are divided into groups I, II, III.

As shown in FIG. 5, the blocks B included in the application pattern P of the paste 5 are divided into six groups.

Specifically, the blocks B included in the application pattern P are divided into two groups I in a set, two groups II in a set, and two groups III in a set.

Then, the groups I forming the set, the groups II forming the set, and the groups III forming the set face each other with the center of the application pattern P in between.

Note that the blocks B included in one group in the present embodiment correspond to two sets of the bridge portions 14a, 14b, 14b shown in FIG. 2.

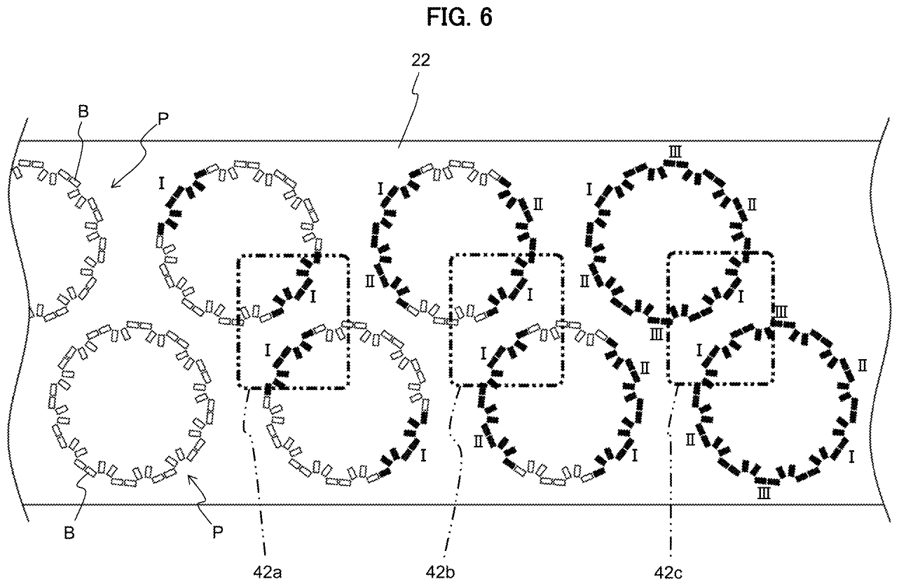

FIG. 6 is a schematic view showing how the electrical steel sheet 22 to which the paste 5 has been applied is partially irradiated with the laser beam in the non-magnetization modification step.

In FIG. 6, open blocks B are portions which have not been irradiated with the laser beam, and black blocks B are portions which have been irradiated with the laser beam. In addition, in FIG. 6, Reference signs I, II, and III represent groups to which the blocks B belong. Reference signs 42a, 42b, 42c indicate positions of laser beam irradiators in a non-magnetization device 40 (see FIG. 7), which will be described later, represented with imaginary lines (dashed-two dotted lines).

As shown in FIG. 6, in the non-magnetization modification step, irradiation timings for the respective groups I, II, III with the laser beam by the laser beam irradiators 42a, 42b, 42c are set not to coincide among the groups I, II, III.

Here, the non-magnetization device according to the present embodiment, which is used in the non-magnetization modification step, will be described.

FIG. 7 is a configuration explanatory view of a non-magnetization device 40 according to the present embodiment.

As shown in FIG. 7, the non-magnetization device 40 includes a conveyance unit 41 for the electrical steel sheet 22, laser beam irradiators 42 which irradiate the electrical steel sheet 22 with the laser beam, and a controller 43 which controls a laser beam irradiation position and a laser beam irradiation timing by the laser beam irradiators 42.

The conveyance unit 41 in the present embodiment is assumed to be two roller pairs 41a, 41b which rotate while holding the electrical steel sheet 22 in between.

The two roller pairs 41a, 41b are disposed while being spaced at a predetermined interval in a conveyance direction of the electrical steel sheet 22.

The roller pair 41a disposed downstream in the conveyance direction of the electrical steel sheet 22 are drive rollers, and intermittently conveys the electrical steel sheet 22 in accordance with a command from the controller 43. In addition, the roller pair 41b disposed upstream in the conveyance direction are driven rollers, and applies a predetermined tension to the electrical steel sheet 22 being conveyed by the roller pair 41a.

The laser beam irradiators 42 in the present embodiment are assumed to be fiber lasers with a scanner function. The laser beam irradiators 42 are disposed between the roller pair 41a and the roller pair 41b. Specifically, as shown in FIG. 5, three laser beam irradiators 42 are arranged side by side in the conveyance direction of the electrical steel sheet 22.

These three laser beam irradiators 42a, 42b, 42c have different laser beam irradiation positions to the application patterns P (see FIG. 4) of the paste 5 (see FIG. 4) on the electrical steel sheet 22 to be conveyed.

Specifically, as shown in FIG. 6, the conveyance unit 41 stops the conveyance of the electrical steel sheet 22 such that the application patterns P of the electrical steel sheet 22 are positioned relative to the laser beam irradiators 42a, 42b, 42c located at positions set in advance.

Then, the laser beam irradiator 42a performs scanning to irradiate, with the laser beam, only the blocks B which belong to the groups I of two pairs of the application patterns P across which this laser beam irradiator 42a is disposed.

In addition, the laser beam irradiator 42b performs scanning to irradiate, with the laser beam, only the blocks B which belong to the groups II of two pairs of the application patterns P across which this laser beam irradiator 42b is disposed.

In addition, the laser beam irradiator 42c performs scanning to irradiate, with the laser beam, only the blocks B which belong to the groups III of two pairs of the application patterns P across which this laser beam irradiator 42c is disposed.

Note that in FIG. 6, the blocks B of the groups I adjacent to the groups II which the laser beam irradiator 42b irradiates with the laser beam are portions which the laser beam irradiator 42a irradiated with the laser beam in the previous step. In addition, in FIG. 6, the blocks B of the groups II adjacent to the groups III which the laser beam irradiator 42c irradiates with the laser beam are portions which the laser beam irradiator 42b irradiated with the laser beam in the previous step. In addition, in FIG. 6, the blocks B of the groups I adjacent to the groups III which the laser beam irradiator 42c irradiates with the laser beam are portions which the laser beam irradiator 42a irradiated with the laser beam in the further previous step.

That is, in the non-magnetization device 40, the conveyance unit 41 intermittently conveys the electrical steel sheet 22 at predetermined intervals, and the laser beam irradiators 42a, 42b, 42c thus irradiate all the application patterns P with the laser beam.

The end point of irradiation with the laser beam by the laser beam irradiators 42a, 42b, 42c is set outside formation portions of the bridge portions 14, and preferably outside the blocks B.

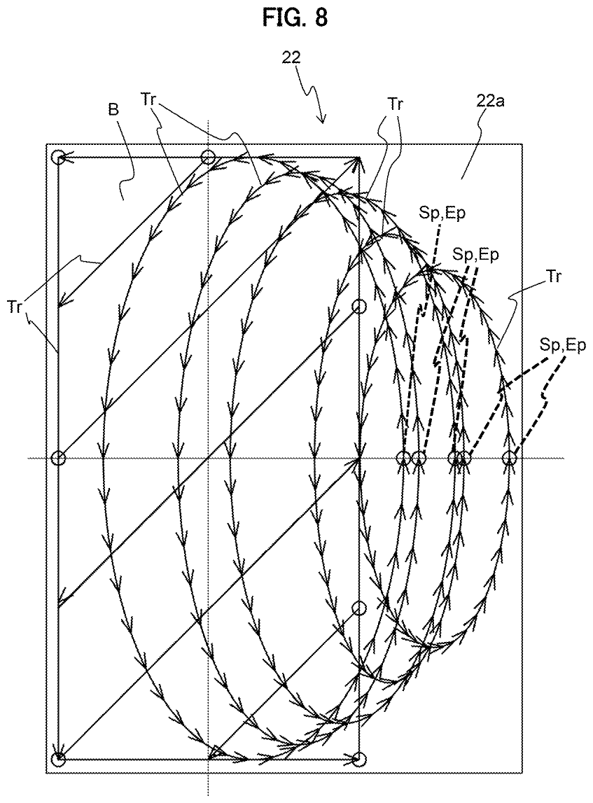

FIG. 8 is a schematic view showing irradiation traces Tr of the laser beam to the electrical steel sheet 22. In FIG. 8, Reference sign B indicates the block, and Reference sign 22a indicates a portion where the magnet housing holes 15a, 15b, 15b and the like are formed by trimming after the irradiation with the laser beam.

In FIG. 8, as indicated by the irradiation traces Tr of the laser beam, the laser beam is emitted in such a manner as to obliquely traverse the block B whose planar shape is a rectangle, and is also emitted in such a manner as to fringe the outline of the block B. In addition, when the laser beam is emitted to the block B such that the irradiation trace Tr of the laser beam draws an ellipse, the start point Sp and the end point Ep of the irradiation with the laser beam are set on the electrical steel sheet 22a outside the block B. Incidentally, in the example shown in FIG. 8, the start point Sp and the end point Ep coincide with each other, but the start point Sp and the end point Ep may be set at different positions.

According to such irradiation with the laser beam, laser marks such as cracks and craters, which are likely to be generated in the start point Sp and the end point Ep of the irradiation with the laser beam, can be prevented from being formed in the electrical steel sheet 18 (see FIG. 2).

Referring back to FIG. 7, the controller 43 of the non-magnetization device 40 coordinates the operation of the conveyance unit 41 and the irradiation timings with the laser beam by the laser beam irradiators 42a, 42b, 42c to perform control such that the irradiations with the laser beam do not coincide with one another among the groups I, II, III.

Such controller 43 may be configured to include a ROM (Read Only Memory) which stores predetermined programs, a RAM (Random Access Memory) onto which the programs stored in the ROM are read out and deployed, and a CPU (Central Processing Unit) which executes the deployed programs and outputs commands to the laser beam irradiators 42a, 42b, 42c and the conveyance unit 41.

Next, the compression and insulation processing step (step S103) shown in FIG. 3 will be described.

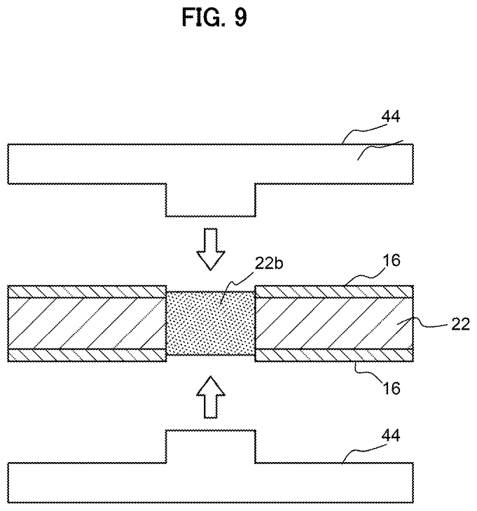

FIG. 9 is an explanatory view of the compression and insulation processing step.

As shown in FIG. 9, in a portion 22b on which the non-magnetization modification has been performed in the electrical steel sheet 22, the insulation coating 16 is removed, and the portion 22b partially bulges.

In the compression and insulation processing step, the portion 22b is sandwiched by a pair of punches 44 to make the thickness of the portion 22b equal to or less than the thickness of the electrical steel sheet 22, which is a general portion, and preferably less than the thickness of the electrical steel sheet 22.

According to such compression and insulation processing step, the portion 22b, which has bulged, is compressed, so that insulation spaces when the electrical steel sheets 18 (see FIG. 2) are stacked can be formed.

Next, the blanking and in-die stacking step (step S104) shown in FIG. 3 will be described.

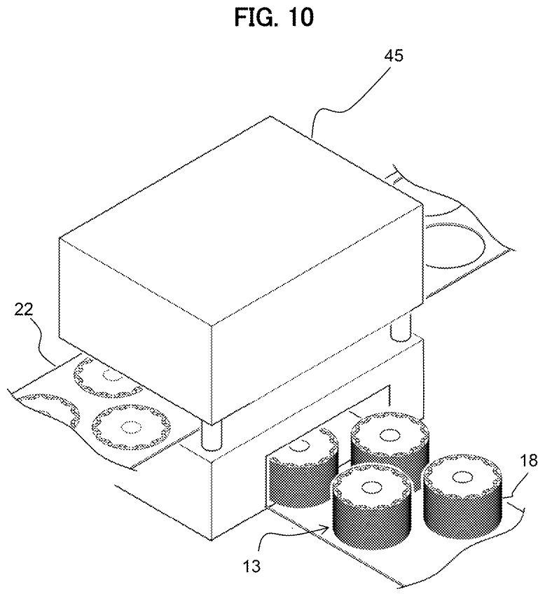

FIG. 10 is an explanatory view of the blanking and in-die stacking step.

As shown in FIG. 10, in the blanking and in-die stacking step, the electrical steel sheet 22 is blanked into a shape corresponding to the planar shape of the rotor core 13 (see FIG. 1) by a blanking and stacking device 45. At this time, as shown in FIG. 2, the bridge portions 14 and the magnet housing holes 15a, 15b, 15b are formed in the electrical steel sheet 22. That is, in a non-magnetization modified portion which is formed by irradiation with the laser beam, portions other than the bridge portions 14 (see FIG. 2) are trimmed.

Then, the electrical steel sheets 18 blanked from the electrical steel sheet 22 (see FIG. 10) are stacked and staked in a predetermined die, and a rotor core 13 stacked is formed and the electrical steel sheets 18 are integrated with an adhesive or the like as necessary, and the blanking and in-die stacking step (step S104) ends. In this way, the rotor core 13 of the present embodiment completed.

### Operations and Effects

Next, the operations and effects exerted by the paste 5 (the non-magnetization modification source-containing paste), the non-magnetization device 40, the rotor core 13, and the method for manufacturing the same according to the present embodiment will be described.

The paste 5 according to the present embodiment is a non-magnetization modification source-containing paste containing a non-magnetization modification source that needs to be melted on a portion that needs non-magnetization modification in an electrical steel sheet 22 in a post-process, the non-magnetization modification source-containing paste including a manganese powder that is the non-magnetization modification source and a resin ink that contains a component capable of being carbonized by heating.

According to such paste 5 (the non-magnetization modification source-containing paste), a Fe—Si—Mn—C alloy can be formed in a portion that needs non-magnetization modification (a portion corresponding to the bridge portion 14) in the electrical steel sheet 22. In this way, the portion corresponding to the bridge portion 14 is non-magnetized, so that the permeability is reduced, and also the strength is improved.

In addition, according to such paste 5 (the non-magnetization modification source-containing paste), the state where the non-magnetization modification source is in contact with the electrical steel sheet 22 can be maintained for a long period of time, unlike the conventional technique in which only a metal powder is attached to a bridge portion (see, for example, WO2022/004672). In addition, according to such paste 5 (the non-magnetization modification source-containing paste), the amount of the non-magnetization modification source can be maintained with high accuracy on a portion which needs non-magnetization modification in the electrical steel sheet 22.

In this way, the paste 5 (the non-magnetization modification source-containing paste) of the present embodiment makes it possible to perform non-magnetization processing of the bridge portion 14 more simply and quickly, and also to reduce the permeability of the bridge portion 14 more sufficiently and stably, than the conventional technique.

The non-magnetization device 40 according to the present embodiment is a non-magnetization device that non-magnetizes each of blocks B (specific portions) formed by applying the paste 5 to portions that need non-magnetization modification in an electrical steel sheet 22 by heating and melting the each of the specific portions, the non-magnetization device including a laser beam irradiator 42 that heats and melts specific portions by changing a laser beam irradiation position so as to correspond to specific portions and a controller 43 that controls a laser beam irradiation position of the laser beam irradiator 42. The controller 43 divides portions that need non-magnetization modification in the electrical steel sheet 22 into groups I, II, and III, and controls a laser beam irradiation position such that timings for melting by heating for the groups I, II, and III do not overlap each other.

According to such non-magnetization device 40, the portions that need non-magnetization modification are divided into the groups I, II, and III, which are separately alloyed into a Fe—Si—Mn—C alloy stepwise. In this way, a residual stress in the non-magnetization modified portions can be reduced. According to the non-magnetization device 40, non-magnetization modified portions in which defects such as cracks are extremely low can be efficiently formed.

In addition, the rotor core 13 according to the present embodiment is a rotor core 13 comprising electrical steel sheets 18 each including a Fe—Si alloy are layered with an insulation coating 16 being interposed between the electrical steel sheets 18. The electrical steel sheets 18 include a bridge portion 14 that has been subjected to non-magnetization modification with the paste 5, and that contains a Fe—Si—Mn—C alloy.

According to such rotor core 13, a rotating electrical machine in which both non-magnetization of a bridge portion 14 and improvement in centrifugal strength of a rotor are achieved can be configured.

In addition, in such rotor core 13, it is desirable that a concentration of carbon [C] be 0.1% by weight or more, and a concentration of manganese [Mn] be 10% by weight or more, in the bridge portion 14.

According to this rotor core 13, non-magnetization of the bridge portion 14 and improvement in centrifugal strength of a rotor can be more surely achieved.

In addition, the method for manufacturing the rotor core 13 according to the present embodiment is a method for manufacturing a rotor core 13 using the paste 5, including a step of applying the paste 5 to portions that need non-magnetization modification in an electrical steel sheet 22 and a non-magnetization modification step for the electrical steel sheet 22, of dividing the blocks B (the portions) to which the paste 5 has been applied in the electrical steel sheet 22 into groups I, II, and III, and melting the blocks B by heating such that timings for melting by heating for the groups I, II, and III do not overlap each other, and then solidifying the portions.

According such method for manufacturing a rotor core 13, non-magnetization modification can be efficiently performed on an electrical steel sheet 22 simply and quickly without generating spatter in applying a non-magnetization modification source to the electrical steel sheet 22, unlike the conventional manufacturing method (see, for example, WO2022/004672).

Although the present embodiment has been described above, the present invention is not limited to the above-described embodiment, and can be implemented in various modes.

### Example

Next, Example of the method for manufacturing a rotor core 13 in the present invention will be described.

In the present Example, preferable ranges for the concentration of carbon [C] and the concentration of manganese [Mn] in a non-magnetization modified portion in the electrical steel sheet 18 to be included in the rotor core 13 was examined.

In the present Example, as the paste 5, a paste containing 90% by weight of a manganese powder, 5% by weight of an acrylic resin as a resin ink, 1% by weight of an organic thixotropy-imparting agent, and 4% by weight of an organic solvent was prepared.

Next, test pieces obtained by applying the paste 5 to the surface of an electrical steel sheet which was made of a Fe—Si alloy and had a thickness of 0.3 mm were fabricated. As the test pieces, 20 types of test pieces in which the application thickness of the paste 5 was changed within a range from 0.16 mm to 0.36 mm were prepared.

Next, portions of the paste 5 applied to these 20 types of test pieces were irradiated with a laser beam, so that the test pieces formed of the electrical steel sheets were partially non-magnetized.

For each non-magnetization modified portion, a relation among the proportion of a ferromagnetic phase (% by volume), the concentration of carbon [C] (% by weight), and the concentration of manganese [Mn] (% by weight) was obtained.

As the proportion of the ferromagnetic phase, the volume ratio of an α-Fe phase was measured by an X-ray diffraction method. As the concentration of carbon [C] (% by weight), carbon contained in a combustion gas in an oxygen stream of the non-magnetization modified portion was measured by an infrared absorption method. The concentration of manganese [Mn] (% by weight) was measured by an ICP emission spectral analysis method.

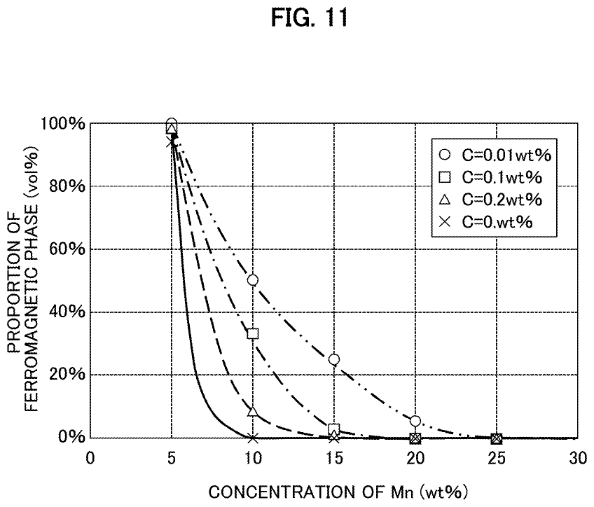

Results are shown in FIG. 11.

FIG. 11 is a graph showing a relation among the proportion of a ferromagnetic phase (% by volume), the concentration of carbon [C] (% by weight), and the concentration of manganese [Mn] (% by weight) in a non-magnetization modified portion.

As shown in FIG. 11, it was verified that by setting the concentration of carbon [C] (% by weight) to 0,1% by weight or more, and preferably to 0.2% by weight or more, and the concentration of manganese [Mn] (% by weight) to 10% by weight or more, and preferably to 15% by weight or more, in the non-magnetization modified portion, the electrical steel sheet of the test piece was subjected to sufficient non-magnetization modification, and the permeability of the non-magnetized portion of the electrical steel sheet can be set to within a preferable range.

Incidentally, in the example shown in FIG. 11, the proportion of the non-magnetization modified portion was 40 (% by volume) or less by setting the concentration of carbon [C] (% by weight) to 0.1% by weight or more and the concentration of manganese [Mn] (% by weight) to 10% by weight or more. In addition, the proportion of the non-magnetization modified portion was 10 (% by volume) or less by setting the concentration of carbon [C] (% by weight) to 0.2% by weight or more, and the concentration of manganese [Mn] (% by weight) to 15% by weight or more.

In addition, as shown in FIG. 11, it was confirmed that by setting the concentration of carbon [C] (% by weight) in the non-magnetization modified portion to from 0.01% by weight to 0.2% by weight or more, the concentration of manganese [Mn] (% by weight) could be reduced from 25 (% by weight) to around 15 (% by weight) while the proportion of the ferromagnetic phase (% by volume) in the non-magnetization modified portion was substantially maintained.

It is understood that the foregoing description is that of the preferred embodiments of the invention and that various changes and modifications may be made thereto without departing from the spirit and scope of the invention as defined in the appended claims.

What is claimed is:

1. A non-magnetization modification source-containing paste containing a non-magnetization modification source which needs to be melted on a portion which needs non-magnetization modification in an electrical steel sheet in a post-process, the non-magnetization modification source-containing paste comprising:
a manganese powder which is a non-magnetization modification source; and
a resin ink containing a component capable of being carbonized by heating.

2. A non-magnetization device configured to non-magnetize each of specific portions formed by applying the non-magnetization modification source-containing paste according to claim 1 to portions which need non-magnetization modification in an electrical steel sheet by heating and melting the each of the specific portions, the non-magnetization device comprising:
a laser beam irradiator configured to heat and melt specific portions by changing a laser beam irradiation position so as to correspond to specific portions; and
a controller configured to control a laser beam irradiation position of the laser beam irradiator, wherein
the controller is configured to divide portions which need non-magnetization modification in an electrical steel sheet into groups and to control a laser beam irradiation position such that timings for melting by heating for the groups do not overlap each other.

3. A rotor core comprising electrical steel sheets each including a Fe—Si alloy, the electrical steel sheets being layered with an insulation coating interposed between adjacent electrical steel sheets, wherein
the electrical steel sheets each include a bridge portion including a Fe—Si—Mn—C alloy, the bridge portion having been subjected to non-magnetization modification with the non-magnetization modification source-containing paste according to claim 1.

4. The rotor core according to claim 3, wherein
the bridge portion has a carbon [C] concentration of 0.1% by weight or more and a manganese [Mn] concentration of 10% by weight or more.

5. A method for manufacturing a rotor core by using the non-magnetization modification source-containing paste according to claim 1, the method comprising:
applying a non-magnetization modification source-containing paste to portions which need non-magnetization modification in an electrical steel sheet;
dividing portions to which the non-magnetization modification source-containing paste has been applied in the electrical steel sheet into groups;
heating and melting the portions such that timings for melting by heating for the groups do not overlap each other; and
solidifying the heated and melted portions.
